(19) United States
(12) Patent Application Publication
(10) Pub. No.: US 2007/0020414 A1
(43) Pub. Date: Jan. 25, 2007

(54) Absorbent article

(75) Inventors: Ronald J. Magargee, Brandon, MS (US); Genevieve H. Kuhn, Albuquerque, NM (US)

Correspondence Address: LYNCH, COX, GILMAN & MAHAN, P.S.C.;Suite 2100, 500 W. Jefferson St., Louisville, NY, 40202, US

(73) Assignee: Sud-Chemie Inc.,, Louisville, KY (US)

(21) Appl. No.: 11/186,527

(22) Filed: Jul. 21, 2005

(51) Int. Cl. B32B 27/32

(52) U.S. Cl. 428/35.2

(57) ABSTRACT

An absorbent article formed from a substantially non-water-degradable packaging material into a pouch containing an absorbent material, wherein at least one edge of the pouch is sealed utilizing a water-soluble adhesive, and wherein upon expansion of the water absorbent material within the pouch caused by exposure to a liquid, the packaging material does not degrade, dissolve or tear.

### CROSS REFERENCED TO RELATED APPLICATIONS

None

### BACKGROUND OF INVENTION

The present invention relates to an improved absorbent article for absorbing fluids, particularly aqueous fluids and chemicals. The absorbent article is composed of a substantially non-water-degradable packaging material formed in the shape of an absorbent article, such as a pouch, which contains a water absorbent material. Because of the choice of the composition of the packaging material, expansion pressure, exerted when the water absorbent material contained within the pouch swells after contact with aqueous fluids, does not degrade, dissolve or tear the packaging material. Instead, one or more of the edges of the packaging material, which is sealed utilizing a water-soluble adhesive, is partially or totally dissolved upon contact of that edge with the aqueous fluid, thereupon releasing at least a portion or substantially all of the water absorbent material from the absorbent article.

There is a recognized need for absorbent articles, particularly packages or pouches, which may be placed in containers to absorb various fluids, such as water, alkaline or acidic liquids, organic liquids, saline solutions, bodily fluids, and a wide variety of other liquids, particularly aqueous fluids and chemicals. It is important that the absorbent material, contained within these articles, be capable of quickly escaping from the article to absorb these fluids. One recognized approach to solve this problem is to construct an absorbent article utilizing packaging material that is fluid degradable, such that upon contact of the article with a fluid, the packaging material quickly dissolves or degrades permitting the absorbent material contained within the articles to be released through the degraded packaging material to absorb the fluids located adjacent thereto.

Various problems exist with such articles, including a delay in the release of the absorbent material caused by the extended period of time that is often necessary for a packaging material of this type to degrade or dissolve after exposure to the fluids and an overall weakness of the packaging material that results from the choice of the particular water degradable packaging material that must be used for the absorbent article.

Another method of absorbing fluids utilizes an absorbent article produced from a substantially water permeable packaging material, which is sealed using at least one weakened seal, such that upon expansion of the absorbent material within the article against the seals of the article, the weakened seal is forced open when sufficient pressure of expansion of the water absorbent material is exerted against that weakened seal. Problems have occurred with this structure because of the delay in separation of the weakened seal. Further, if a portion of the absorbent article, other than the portion adjacent to the weakened seal, is first exposed to the fluid, the water absorbent material contained within the article as it swells sometimes fails to quickly apply sufficient pressure to that portion of the article containing the weakened seal, resulting in long delays in the release of the absorbent material from the article. In addition, the processes that are utilized to form weakened seals in these absorbent articles may result in a reduction in the overall strength of the absorbent article.

Accordingly, it is an object of this invention to disclose an improved absorbent article which solves the problems of the prior art articles.

These and other objects of the invention can be obtained by the absorbent articles of the invention, the processes for formation of the absorbent articles and the processes of use of the absorbent articles, which are disclosed herein.

### SUMMARY OF THE INVENTION

The present invention is an absorbent article comprising a substantially non-water-degradable packaging material formed into a pouch (10), or other absorbent product, containing a water absorbent material (20), wherein at least a portion of at least one edge (30) of the pouch (10) is sealed utilizing a water-soluble adhesive; wherein upon expansion of the water absorbent material (20) within the pouch (10), the packaging material does not readily degrade, dissolve or tear. Rather, upon expansion, the water absorbent material (20) escapes from the pouch (10) through an opening formed in at least one edge (30), which was formerly sealed with the water soluble adhesive. The opening in the edge (30) of the pouch (10) is created by the dissolving of the water soluble adhesive which forms the seal of the edge (30), after contact of that adhesive with the aqueous fluid.

Preferably, the packaging material that forms the pouch (10) has reduced water permeability, such that when the pouch (10) is first exposed to the aqueous fluid, at least one of the edges (30) of the pouch (10), which is sealed using the water-soluble adhesive, separates prior to sufficient exposure of the water absorbent material (20) contained within the pouch (10) to the aqueous fluid to cause expansion of the water absorbent material to the degree necessary to exert pressure on the seals at the edges (30) of the pouch (10).

The invention is also a process of use of the absorbent article of the invention for the absorption of fluids, particularly aqueous fluids.

The invention is also a process for the manufacture of the absorbent article of the invention comprising forming a pouch (10) from substantially non-water-degradable packaging material, enclosing within that pouch (10) water absorbent material (20), and sealing the edges (30) of the pouch (10), such that at least a portion or all of at least one edge (30) of the pouch (10) is sealed utilizing a water-soluble adhesive, wherein the packaging material is comprised of a material that does not dissolve, degrade or tear upon expansion of the water absorbent material (20) within the pouch (10).

### BRIEF DESCRIPTION OF THE DRAWINGS

FIG. 1 is a perspective view of an improved absorbent article of the invention sitting on top of a fluid within a container.

FIG. 2 is a transverse, cutaway, cross-sectional view of the article of FIG. 1, prior to contact of the article with the fluid.

FIG. 3 is a perspective view of the article of FIG. 1 within the container after the seal of one edge of the article has been dissolved by the fluid and the absorbent has begun to swell within the article.

FIG. 4 is a top view of the article of FIG. 1 within the container after a period of time, wherein the absorbent has expanded out of the article to absorb the fluid in the container.

### DETAILED DESCRIPTION OF THE INVENTION

The invention is an absorbent product or article, for example a pouch (10), formed from a non-water-degradable packaging material, containing a water absorbent material (20), wherein at least a portion or all of at least one edge (30) of the pouch (10) is sealed utilizing a water-soluble adhesive, and wherein upon expansion of the water absorbent material within the pouch (10), when exposed to an aqueous fluid, the packaging material does not degrade, dissolve or tear.

While the absorbent material contained within the pouch is described as a “water absorbent material”, it is understood that this invention is not limited to products which absorb water only but includes products which absorb fluids which are normally absorbed by use of this type of absorbent articles. These fluids include water, aqueous solutions, alkaline or acidic liquids, some organic liquids, saline solutions, body fluids, such as urine, and a wide variety of other types of fluids, although the general application of the absorbent article is for the absorbency of aqueous fluids and chemicals.

The packaging material for the pouch (10) is formed from a substantially non-water-degradable packaging material. “Non-water-degradable” packaging material generally means that upon expansion of the water absorbent material upon exposure to an aqueous fluid or chemical, the packaging material does not degrade, dissolve or tear even if the swollen water absorbent material exerts pressure against the packaging material. One measure of the strength of this non-water-degradable packaging material is its tensile strength. In one embodiment the non-water-degradable packaging material has a wet tensile strength greater than about 350 grams per inch-force in the cross-machine direction (TAPPI T 456 om-87) and a dry tensile strength greater than about 1020 grams per inch-force in the cross-machine direction (ASTM D828-93).

The non-water-degradable packaging material can be formed from any material which has resistance to dissolution, degradation and tearing when exposed to the types of fluid described above and particularly has such resistance when placed under pressure by the swelling of an absorbent material contained within such packaging material, when either wet or dry. The non-water-degradable packaging material should not be produced from materials which readily degrade, dissolve or tear when exposed to fluids, particularly aqueous fluids, such as packaging material composed of starch, polyethylene oxide (PEO), and polyvinyl alcohol (PVA). Specifically, the packaging material should not be formed from the types of packaging material that are disclosed in U.S. Pat. Nos. 5,356,678, 4,853,266, 4,749,600 and 4,748,069. One particular example of a non-preferred material is DISOLVO® paper, which is discussed in U.S. Pat. No. 4,725,465.

In one preferred embodiment, the packaging material is a wet formed, light weight, non-woven packaging material comprised of an acrylic coated cellulose paper produced by Oliver Products Company. It has a wet tensile strength of 600 grams per inch-force cross-machine direction (TAPPI T 456 om-87) and a dry tensile strength of 1550 grams per inch-force cross-machine direction (ASTM D828-93). Other similarly performing packaging materials are included in this invention.

The water solubility of the packaging material can be measured by the Klemm Test (ISO 8787:1986, ISO Standards Handbook: Paper, board and pulps). This test measures the ability of a sheet of material to absorb water by measuring the vertical capillary rise of water in a 1 inch strip of the material for a specific period of time. The values are reported in Klemms. One Klemm is defined as a capillary rise of 1/16th inch. For the non-water-degradable packaging material of this invention, it is preferable to use a material that has a Klemm rating no more than about 15 Klemms, more preferably less than about 10 Klemms, and most preferably less than 5 Klemms.

Another important aspect of the invention is that at least a portion or all of at least one of the edges (30) of the pouch (10) becomes unsealed prior to the expansion of the absorbent material (20) beyond the confines of the pouch. For this invention, the sealed edge preferably becomes unsealed as a result of dissolution of the substantially water-soluble adhesive material which has been used to seal at least a portion of that edge of the pouch. The water-soluble adhesive used to seal the edge preferably loses adhesion quickly when exposed to the aqueous fluid, and at least a portion or all of one entire edge of the pouch opens as a result of the dissolution of the water-soluble adhesive that is used to seal that edge prior to any pressure being placed on that seal from the expansion of the enclosed water absorbent material. Accordingly, in a most preferred embodiment, the aqueous fluid that is adjacent to or associated with the pouch substantially dissolves the water-soluble adhesive prior to the expansion of the water absorbent material contained within the pouch against the seal from the inside of the pouch.

The absorbent article can be formed either from a single sheet of the non-water-degradable packaging material, which is folded on itself or from two separate sheets, which are sealed together around all edges of the packaging material.

As stated above, at least a portion of at least one of the edges of the pouch (10) must be sealed with the water-soluble adhesive material. If preferred, all of the edges (30) of the pouch (10) may be sealed using the water-soluble adhesive material. In an alternative embodiment, less than all of the edges (30) of the pouch (10) are sealed with a non-water-soluble adhesive material and one or more of the remaining edges are sealed using a non-water-soluble adhesive that has a greater resistance to water solubility than the water-soluble adhesive. By use of this alternative arrangement, the water absorbent material, after contact of the pouch with the water, passes outward from the pouch primarily or only through the open edge of the pouch which becomes unsealed as a result of its dissolution in the aqueous fluid.

In a further alternative embodiment, one of the seals of the pouch, even if all are formed from a water-soluble adhesive, may be made weaker than the other seals by known methods of weakening of seals. For example, it is well recognized that the seal strength of a seal is often determined by the temperature at which the seal is secured. Preferably, the seals of the absorbent article are formed by heat sealing the edges at a temperature from about 105° C. to about 200° C. Generally, the strength of a seal increases with increases in the temperature of a seal bar which is used to seal the two sides of packaging material together. If desired, the strength of one of the seals can be reduced by reducing the temperature at which that edge of the pouch is sealed. The invention includes absorbent articles formed into pouches where the edges of the pouch are sealed at different temperatures and where the sealing material is formed from both water soluble adhesives and conventional adhesives with reduced or significantly reduced solubility in aqueous fluids, as long as at least a part or all of one of the seals of the edge of the pouch is formed from a water-soluble adhesive.

The water soluble adhesive material can be any adhesive material which has significant and rapid water solubility. Examples of such adhesive materials include those produced from a rubber dispersion, starch paste, vinyl acetate, polyvinyl alcohol, polyethylene oxide, polyamide and other similar adhesives. Preferably, a polyamide adhesive material is chosen, such that upon contact of the seal with a fluid, preferably an aqueous fluid, for a period in excess of as short as 30 seconds or so, the seal becomes totally or at least partially solubilized by the fluid. One measure of the solubility of the adhesive of the seal is shown from a reduction in the pressure that is necessary to separate the seal, as discussed in the example.

When the packaging material for the absorbent article is fabricated, the adhesive material is preferably secured to the inner surface of the packaging material. The adhesive material may be secured to this inner surface in a number of patterns, including a dot matrix pattern, as desired. Alternatively, a continuous coating of the adhesive material may be utilized to provide additional strength to the seals of the edges of the absorbent articles. Furthermore, seals with enhanced strength may be created by securing an inner surface of one side of the absorbent article to an inner surface of a second piece of the packaging material to which the adhesive material has already been applied. Alternatively, the adhesive material may be applied to only one inner surface of the packaging material that is utilized to form the seal.

A number of different materials can be utilized as the water absorbent material (20) which is contained within the pouch (10) of the invention. In addition, the composition of the water absorbent material can be modified depending upon the type of fluid that is to be absorbed by the pouch. Further, additives can be added to the absorbent material to enhance its ability to absorb particular fluids or to perform other necessary operations depending on the nature and characteristics of the fluid to be absorbed. A number of absorbent materials are known and well recognized in the industry, including those disclosed in U.S. Pat. No. 5,356,678, the contents of which are incorporated herein by reference. In a preferred embodiment the water soluble absorbent material comprises a salt of a cross-linked polyacrylic acid. While sodium salts of cross-linked polyacrylic acid are generally preferred to form the water absorbent material, such as is sold by BASF, and may be used as the only absorbent material contained within the absorbent article, other salts of polyacrylic acid may also be utilized for the absorption of the fluids, particularly aqueous fluids alone or in combination with the sodium salts, such as potassium salts.

The applicants have surprisingly discovered that blends of sodium salts of polyacrylate with potassium salts of polyacrylate show improved performance as the water absorbent material (20) for the pouch (10) of the invention over use of either salt when used alone. Preferred embodiments are produced when the ratio of the sodium polyacrylate to the potassium polyacrylate range from 5:1 to 1:5. The applicants have surprisingly discovered that more preferred absorbent articles are produced when the ratio of the sodium polyacrylate to the potassium polyacrylate is from 3:1 to about 2:1 and the most preferred ratio is about 1:1. Increases in the ratio of the potassium polyacrylate within the water absorbent material absorb the liquid quicker while the ratio of the sodium polyacrylate may be increased if increased internal pressure is desired for the absorbent material within the article. Notwithstanding, absorbent articles containing only a single type of salt of polyacrylate may also be used within the absorbent article.

By utilization of a combination of sodium polyacrylate with potassium polyacrylate as described above, there is a delay in the initial expansion of the absorbent material to permit one or more edges of the absorbent article that are sealed with the water soluble adhesive material to become unsealed as a result of the solubility of the water soluble adhesive material holding that edge together.

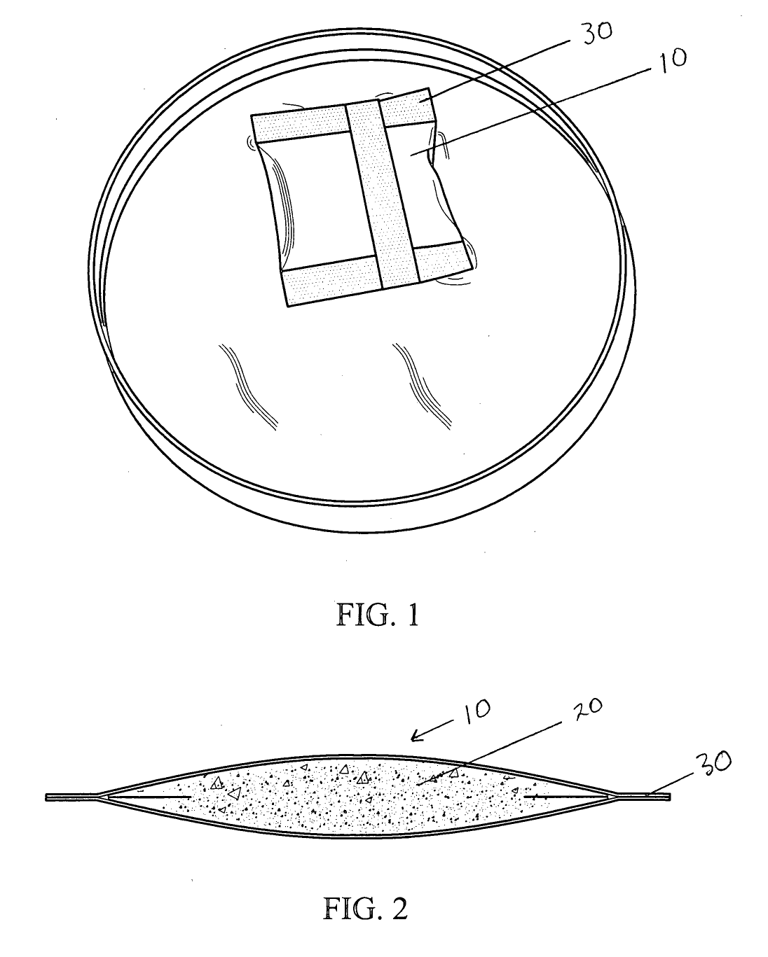

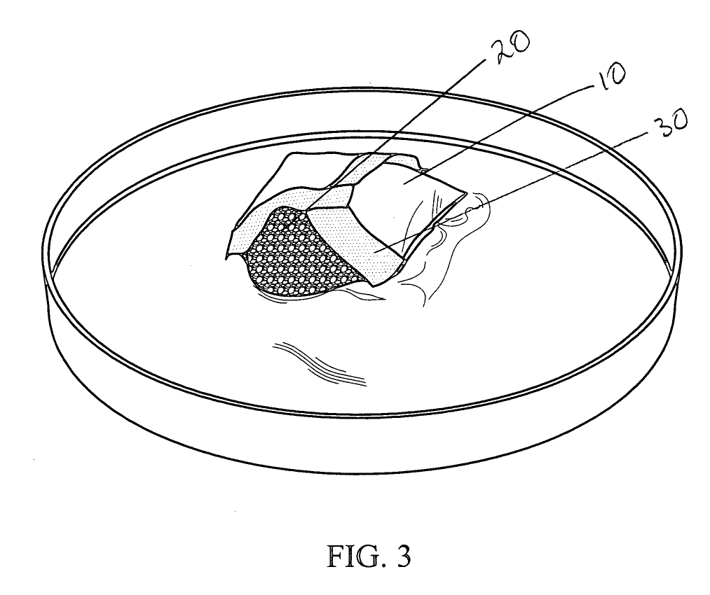

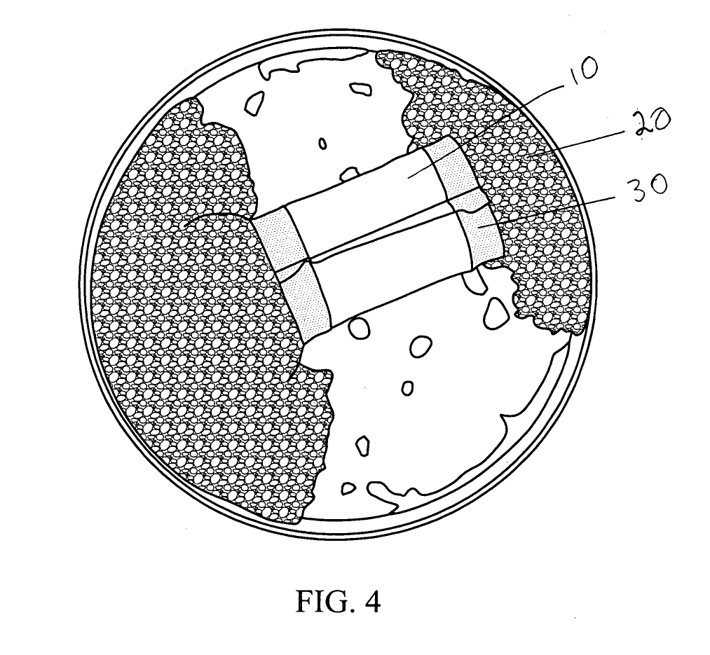

As illustrated in FIGS. 1-4, the pouch (10) of the invention is formed from either a single sheet of a substantially non-water-degradable packaging material folded on itself or from two sheets of packaging material, wherein the edges of two sheets of material are sealed together. The applicants have surprisingly discovered that an improved pouch (10) is produced when at least a portion or all of one or more of these seals of the edges (30) of the pouch (10) are formed utilizing a water-soluble adhesive material. Preferably, when the adhesive seal formed from a water-soluble adhesive is exposed to an aqueous solution at a temperature of at least about 20° C., at least one of the seals of the edges formed from the adhesive material become unsealed quickly, i.e., within no more than about 120 seconds, preferably no more than about 60 seconds and most preferably within 30 seconds or so.

The applicants have also surprisingly discovered that the pouch (10) works best when the water wicking ability of the packaging material is reduced to about 5 Klemms or less. By reducing the water wicking ability of the packaging material, aqueous fluids contained on the outside of the packaging material are delayed in entry into the absorbent article for a sufficient time to permit the seal of the edge (30), which is formed from the water soluble adhesive, to become unsealed. Even if some fluid enters the pouch (10) prior to total dissolution of the seal, expansion of the water absorbent material (20) is limited within the pouch (10) when the appropriate type of packaging material and absorbent material are utilized. Regardless of the pressure placed on the sealed edges (30) from the expansion of the water absorbent material (20) or the length of time of exposure of the sealed edges (30) to the fluid, the packaging material when properly chosen does not degrade, dissolve or tear.

In one mode of operation of the absorbent article or pouch (10), it is inserted into a container which acts as an outer container for a frangible inner container. The inner container may contain a liquid material. Upon breakage of the inner container or leakage of liquid from the inner container, the absorbent material (20) contained in the pouch (10) absorbs the leakage or spillage from that inner container. The liquid from the inner container initially contacts the sealed edges (30) of the pouch (10), which are sealed with the water-soluble adhesive material. Within a short period of time, preferably less than about 60 seconds or so, the water-soluble adhesive material, which seals together the edges (30) of the pouch (10), becomes unsealed as a result of the solubility of the adhesive material by the liquid that has been spilled. This liquid does not substantially permeate the pouch (10) as the packaging material for the pouch (10) is selected such that it is substantially impermeable to the liquid. The absorbent material (20) then escapes from the pouch (10) through the dissolved sealed edge (30), which has opened as a result of dissolution caused by the liquid. The absorbent material (20) rapidly spreads to absorb the liquid and thus prevents significant damage caused by the leakage of this liquid. It is understood that the amount of the absorbent material (20) that is present within the pouch (10) should be sufficient to absorb all or substantially all of the liquid that may be present in the inner container.

### EXAMPLE

The seal strength of the packaging material for an absorbent article of the invention is disclosed by the following experiment. The seal strength of edges of samples of the article is determined using a Mark 10 series model EG 100 (100×0.1 LB) tensile strength tester. Samples of sealed edges of various absorbent articles are chosen which are formed from acrylic coated cellulose paper (30.2 grams basis weight). The edges of these absorbent articles are sealed using a conventional horizontal seal bar operating at the various temperatures listed in Table 1. The area of each article which is sealed is consistent. Each article is cut perpendicular to the seal to be tested so that there is approximately a 1 inch wide strip, each end of which is not sealed. Each unsealed end of the strip is then inserted into an upper and lower grip of the seal strength testing equipment. The pressure on the seal is increased until the seal is broken. Each seal is tested both when dry and after having been submerged in distilled water for 30 seconds. The results are shown in the following Table 1.

TABLE 1

| | Horizontal Seal | Seal Area | Seal | |
|---|---|---|---|---|
| Sample | Bar Temperature | Avg. | Strength Dry | Seal Strength Wet |
| No. | (° F.) | (mm²) | (lb/linear in.) | (lb/linear in.) |
| 1 | 215 | 204.42 | 0.4 | 0.1 |
| 2 | 215 | 204.42 | 0.4 | 0.0 |
| 3 | 220 | 204.42 | 0.6 | 0.1 |
| 4 | 220 | 204.42 | 0.6 | 0.1 |
| 5 | 230 | 204.42 | 0.9 | 0.1 |
| 6 | 230 | 204.42 | 0.9 | 0.1 |
| 7 | 240 | 204.42 | 2.1 | 0.0 |

As is shown from these tests, by use of the water-soluble adhesive, the seal strength when exposed to water even for only 30 seconds is either substantially reduced or completely eliminated. With this loss of seal strength, the expanding absorbent material can easily pass through the formerly sealed edge of the pouch or absorbent article to absorb adjacent fluids.

It will be apparent from the forgoing that while particular forms of the invention have been illustrated, various modifications can be made without departing from the scope of the invention. Accordingly, the specification is not intended to limit the invention, except as noted therein.

1. An absorbent article comprising one or more sheets of a substantially non-water-degradable packaging material formed into a pouch containing one or more sealed edges, wherein the pouch contains a water absorbent material; wherein at least a portion of at least one sealed edge of the pouch is sealed utilizing a water-soluble adhesive; wherein upon contact of the water absorbent material with an aqueous solution, there is expansion of the water absorbent material; and wherein upon expansion of the water absorbent material when exposed to the aqueous solution, the packaging material does not degrade, tear or dissolve.

2. The absorbent article of claim 1, wherein upon contact of the absorbent article with the aqueous solution, at least a portion of the edge of the pouch that is sealed with the water-soluble adhesive becomes unsealed prior to expansion of the water absorbent material against that sealed edge caused by contact of the water absorbent material with the aqueous solution.

3. The absorbent article of claim 1, wherein the packaging material has a reduced water wicking ability.

4. The packaging material of claim 3, wherein the water wicking ability of the packaging material is about 15 Klemms or less.

5. The absorbent article of claim 1, wherein the packaging material has a wet tensile strength of at least about 350 gram-force per inch cross machine direction.

6. The absorbent article of claim 1, wherein the water absorbent material comprises a mixture of sodium polyacrylate and potassium polyacrylate.

7. The absorbent article of claim 6, wherein the ratio of the sodium polyacrylate to the potassium polyacrylate is from about 5:1 to about 1:5.

8. The absorbent article of claim 1, wherein at least a portion of one sealed edge of the pouch is sealed with a non-water soluble adhesive.

9. The absorbent article of claim 1, wherein the packaging material is comprised of a coated, cellulose paper.

10. The absorbent article of claim 1, wherein the pouch is formed from a single sheet of packaging material folded over on itself.

11. The absorbent article of claim 1, wherein the pouch is formed from two sheets of packaging material sealed together.

12. The absorbent article of claim 1, wherein at least a portion of one of the sealed edges of the pouch is sealed with seal strength greater than another portion of one of the sealed edges of the pouch.

13. An absorbent article comprising one or more sheets of a substantially non-water-degradable packaging material formed into a pouch with one or more sealed edges; wherein the pouch contains a water absorbent material; wherein at least one sealed edge of the pouch is sealed utilizing a water-soluble adhesive; wherein the packaging material has a reduced water wicking ability; and wherein upon expansion of the water absorbent material when exposed to an aqueous solution, the packaging material does not degrade, dissolve or tear.

14. The packaging material of claim 13, wherein the water wicking ability of the packaging material is about 5 Klemms or less.

15. The absorbent article of claim 13, wherein the water absorbent material comprises a mixture of sodium polyacrylate and potassium polyacrylate.

16. The absorbent article of claim 13, wherein at least a portion of one of the sealed edges of the pouch is sealed with a seal strength greater than another portion of one of the sealed edges of the pouch.

17. The absorbent article of claim 13, wherein upon contact of the absorbent article with the aqueous solution, at least a portion of the edge of the pouch that is sealed with the water-soluble adhesive becomes unsealed prior to expansion of the water absorbent material against that sealed edge caused by contact of the water absorbent material with the aqueous solution.

18. An absorbent article comprising a substantially non-water-degradable packaging material with a water wicking ability of less than about 10 Klemms formed into a pouch with one or more sealed edges; wherein the pouch contains a water absorbent material; wherein one or more of the sealed edges of the pouch are sealed utilizing a water-soluble adhesive; wherein the water absorbent material comprises a mixture of sodium polyacrylate and potassium polyacrylate at a ratio of from about 5:1 to about 1:5; and wherein upon expansion of the water absorbent material when exposed to an aqueous solution, the packaging material does not degrade, tear or dissolve when exposed to water.

19. The absorbent article of claim 18, wherein at least a portion of one of the sealed edges of the pouch is sealed with a seal strength greater than another portion of the sealed edges of the pouch.

20. The absorbent article of claim 18, wherein upon contact of the absorbent article with the aqueous solution, at least a portion of the edge of the pouch that is sealed with the water-soluble adhesive becomes unsealed prior to expansion of the water absorbent material against that sealed edge caused by contact of the water absorbent material with the aqueous solution.
